(19) United States
(12) Patent Application Publication
(10) Pub. No.: US 2026/0262865 A1
(43) Pub. Date: Sep. 10, 2026

(54) MULTILAYER BASE FOR COOKWARE

(71) Applicant: Fissler GmbH, Idar-Oberstein (DE)

(72) Inventors: Ingo KUBIK, St Wendel (DE); Benjamin HEIDRICH, Idar-Oberstein (DE)

(21) Appl. No.: 19/556,638

(22) Filed: Mar. 4, 2026

(30) Foreign Application Priority Data
Mar. 5, 2025 (DE) 10 2025 108 315.0

(51) Int. Cl. A47J 27/00

(52) U.S. Cl. CPC A47J 27/002

(57) ABSTRACT

The invention relates to a multilayer base (22) for a cookware item (20) with a preparation space (24) for the preparation of food, including an outer layer (26) that faces a substrate and that is made of a first material and an interior layer (28) that is adjacent to the outer layer (26) in the direction of the preparation space (24) and that is made of a second material. The outer layer (26) includes at least one groove (31) in its outer surface (30) that faces away from the interior layer (28), wherein a groove depth (T) is between 50% and 95% of a layer thickness (H) of the outer layer (26).

### CROSS-REFERENCE TO RELATED APPLICATIONS

This application claims the benefit of German patent application no. 10 2025 108 315.0, filed on 5 Mar. 2025, the disclosure of which is incorporated herein by reference in its entirety.

### TECHNICAL FIELD

The present disclosure relates to a multilayer base for a cookware item with a preparation space for the preparation of food, including an outer layer that faces a substrate and that is made of a first material and an interior layer that is adjacent to the outer layer in the direction of the preparation space and that is made of a second material.

### BACKGROUND

An essential, if not the most essential, characteristic of the quality of cookware is the geometric design and long-term geometric stability of the cookware base for a lasting optimal heating performance as well as a safe and ergonomic handling during use.

A cookware item should be stable on all types of heating units, i.e. stovetops/heat sources, without wobbling or rocking, and there should be as little distance as possible between the potential supporting surface and the base of the implement throughout the entire application cycle.

The stable support of the cooking implement on the heat source, without wobbling or rocking, is an essential safety aspect. Any movement of the upright hot cooking implement during use that is unforeseen or not expected by the user can result in the user accidentally coming into contact with the hot surfaces and suffering burns. For example, the base of the cooking implement can temporarily or permanently—due to a lack of long-term stability—exhibit an outward bulge during use and thus only lies on the potential supporting surface of the heating source centrally, at the highest point of the bulge. Such a cookware item not only wobbles and rocks but can also very easily be made to rotate or slide, as the very small supporting surface results in very little friction.

For instance, the force that results from, e.g., the torque introduced by stirring soup with a spoon can overcome the frictional force, which brings about a rotation of the cookware item, which the user must then stop. It frequently occurs that the user does not have a free hand available at this moment, as one hand is holding the spoon and the other hand is holding, e.g., the lid of the cookware item, which can result in rash actions that lead to burns.

The geometric design and long-term geometric stability of the base of the cooking implement is also a key factor, depending on the heat source, for an enduringly good heating performance. For example, with induction heating sources, an unsuitable base geometry can be disadvantageous due to fact that, as a distance of the ferritic base material of the cooking implement from the induction coils of the heating source increases, the inductive power coupling gradually decreases to a point where by definition the heating source no longer detects the cookware item (protective circuit) and heating stops completely. However, the greatest effects on heating behaviour are usually seen with heating sources that can only transfer their heat energy to the cookware item exclusively or chiefly indirectly via heat conduction. These include all heat sources that work with embedded or covered resistance heating elements, the classic, commonly known as plate and Ceran stovetops. The smaller the supporting surface and the greater the distance between the base of the cooking implement and the potential supporting surface of the heat source, the greater the air cushion between the base of the cooking implement and the heat source. Since air has comparatively poor heat conduction properties, the transfer of heat energy from the heat source to the base of the cookware item is significantly impaired. In addition to the cooking implement taking longer to heat up, it is even possible that temperatures required for, e.g., frying and deep-frying can no longer be reached.

In the field of cookware technology, it is common to use multilayer bases to achieve an even heat distribution and improved cooking performance. Known systems typically include a combination of different metals arranged in layers to optimise thermal conductivity and ensure the structural integrity of the cookware item. A frequently used combination includes a layer of a robust material such as stainless steel, which is valued for its corrosion resistance and durability, and a layer of a material with a high thermal conductivity, such as aluminium or copper, to ensure an efficient heat transfer.

The one-sided heating and in particular the use of different metal pairings with different thermal expansion coefficients give rise to deformations and tension in the material. Further extreme increases in tension are produced when, after heating, the item being cooked is “deglazed” with a cold food item (e.g. wine) or water, which can be recommended for some dishes. Rapidly induced, one-sided temperature changes from hot to cold cause the material to contract sharply from the inside of the cooking implement within a few milliseconds, while the outer material layers or cross sections remain in a hot state. This creates immense tensile and compressive stresses in the material cross section and, as a result, bending stresses which, if a critical threshold is exceeded, lead to plastic, i.e. irreversible, material deformation.

Multilayer materials are especially susceptible to very large, potentially permanent deformations, as different materials are permanently joined together and act like a bimetal.

Despite the good characteristics of such multilayer bases, there are thus challenges associated with the thermal expansion and resulting stresses between the different layers. The described deformations impair the performance of the cookware item and shorten its service life.

Known products strive to minimise these stresses by using materials with similar thermal expansion coefficients or by adding additional layers that act as buffers between the layers. However, these approaches are associated with high manufacturing costs and a complex production. Another problem is that the conventional methods for reducing deformation are often not sufficient to meet the requirements of modern cookware, which is frequently used on induction stovetops or other high-power heat sources. These conditions require a control of thermal expansion that is even more precise to ensure an optimum performance.

### SUMMARY

The disclosure provides a multilayer base system that at least partially overcomes the disadvantages of known systems, is inexpensive to manufacture, yet still ensures a long service life of the products.

This is achieved according to the disclosure by providing means of a multilayer base with the features of the independent claim.

The disclosure makes it possible to significantly reduce the resulting bending stresses that are generated during use as well as during testing procedures in the manufacturing process. As a result, instances of irreversible plastic deformation are significantly reduced over the planned service life of the product. This in turn allows the base curvature introduced during manufacture (concave support surface) to be significantly reduced, so that the distance between the base of the cooking implement and the potential supporting surface of the heat source is as small as possible and the best possible heating behaviour is achieved over time.

As a further positive side effect, the disclosure can also be used or configured specifically as a design element in order to achieve a certain differentiation from competitors.

The term “multilayer base” denotes a base that consists of a plurality of layers of different materials in order to achieve specific characteristics.

The structure of a multilayer base is usually “monolithic”. Due to the need for a compatibility with induction stovetops, the outer layer is preferably made of ferritic stainless steel. The outer layer lies with its outer surface directly on a substrate or heat source and is therefore robust and resistant to mechanical and thermal stresses. A base layer in the preparation space forms the floor of the cookware item and is preferably made of a material that is suitable and approved for contact with food, such as austenitic stainless steel. Provided between these two layers is the interior layer, which consists of a material that is suitable for forming a material bond with stainless steels under conditions of high pressure and high temperature (roll bonding), which bond exhibits a sufficient stability from a thermomechanical point of view. In addition, this interior layer is also essential to achieve a base stability that is sufficient for the intended application. Aluminium has proven to be a particularly advantageous material for this interior layer, although it is also possible to use copper.

A multilayer base can also comprise more than three layers, wherein additional layers of suitable materials can be provided between the outer layer and the floor layer.

Starting from the preparation space and moving towards the outer surface, plies consisting of the following materials can be provided, for example:
Steel
Aluminium
Induction-compatible steel

or
Steel
Aluminium
Steel
Aluminium
Induction-compatible steel

or
Steel

3 plies of aluminium
Steel (induction-compatible)

According to the disclosure, the outer layer includes at least one groove in its outer surface, the groove depth of which is between 50% and 95% of the thickness of the outer layer.

According to the disclosure, the outer layer of the multilayer base is attenuated at least in the transition area from the base to a wall of the cookware item by means of a specific geometric recess so that its effect as a tension and compression brace is significantly reduced in the event of rapidly induced, one-sided temperature changes in the cookware item. The groove brings about a reduction in the thermal influence of the outer layer on the interior layer and reduces the associated bending stresses which, if a critical threshold is exceeded, lead to plastic, i.e. irreversible material deformations in the base area. Tests have shown that plastic deformations caused in test procedures could be reduced by a margin clearly in a double-digit percentage range compared to multilayer bases without the groove according to the disclosure.

The groove allows the outer layer to expand and contract as the result of thermal influences. By reducing stresses and deformations, it is possible to reduce the otherwise necessary compensatory base curvature created at manufacture by 10-15%.

In practice, this results in this context in the three essential effect mechanisms explained in the following:

### Case 1

1.1 The cookware item is completely cold, i.e. homogeneously at room temperature.
1.2 The outer layer (the base) is heated by the hotplate and expands first. The other layers in the base are still cold, which gives rise to the bimetallic effect (effect 1), which causes tension that causes the base to form an outward bulge (the so-called spinner). There is, however, a further effect (effect 2) that causes the base to form an outward bulge: the expansion of the outer layer is prevented by the vessel body (i.e. the peripheral wall), as this is initially still cold (room temperature) and has not expanded in diameter. A geometric attenuation directly in the transition area from the outer layer to the wall mitigates this effect 2 accordingly. The greater the attenuation, the greater the mitigation.
The described effect 1 can, however, also be mitigated according to the disclosure by geometric attenuations in the outer layer. These geometric attenuations must be provided, in this case, in the surface of the outer layer (at least one or more preferably grooves extending in a circle at different radii or radial grooves that divide the outer layer optically into “pie slices”, or both, etc.). In summary, as many “thin areas” as possible must be created in the outer layer so that the forces (compressive forces) generated by the expansion “die out” in the “thin areas” or can no longer be transmitted completely.

### Case 2

2.1 The cookware item is already completely hot, i.e. homogeneously at application temperature.
2.2 The interior layer (inner vessel floor) is now suddenly cooled (in the test with cold water, in practice with cream, wine, etc.). The interior layer contracts suddenly, the further outer layers in the base are still hot, and the same bimetal effect (effect 1) as described above in 1.2 occurs, which causes the base to form an outward bulge (spinner). In this case as well, there is a further effect (effect 3) that causes the base to form an outward bulge:
The tensile stresses generated in the interior layer are strong enough to cause the diameter of the vessel body to contract. This in turn leads to compressive stresses, which act on the outer layer in the transition area between the wall and the base, causing the outer layer to be compressed. The same geometric attenuations according to the disclosure described above for case 1 are helpful in mitigating the effects 1 and 3 in this case 2 as well. Only compressive forces are acting in the “thin areas” in this case too.

### Case 3

3.1 The cookware item is completely cold, i.e. homogeneously at room temperature.
3.2 Hot liquid is poured into the vessel, the interior layer (inner vessel floor) is now heated and expands first. The further layers in the base are still cold and the bimetal effect (effect 1) occurs, causing stresses that cause the base to form an inward bulge. A further effect (effect 4) that occurs in this case is as follows:
The compressive stresses generated in the interior layer are strong enough to cause the diameter of the vessel body to expand. This in turn leads to tensile stresses, which act on the outer layer in the transition area between the wall and the base, causing the outer layer to be pulled. The expansion of the vessel body due to the compressive stresses generated in the interior layer is thus in a way prevented by the outer layer. A geometric attenuation directly in the transition area between the outer layer and the vessel wall mitigates this effect 4 accordingly. The greater the attenuation, the greater the mitigation. The same geometric attenuations according to the disclosure described above for case 1 are thus also helpful in mitigating the effects 1 and 4 in this case 3 as well. In this case, only tensile forces are acting in the “thin areas”.

The groove depth is a measure of the depth of the groove from the outer surface to the bottom of the groove and, according to the disclosure, is between 50% and 95%, preferably 55% to 80%, of the thickness of the outer layer. A depth of approximately 60% has proven to be particularly suitable. This means that the groove is deep enough to fulfil its separating function but does not extend through the entire outer layer. This is important because otherwise the interior layer, which is generally more sensitive to external exposure, would be uncovered and could be destroyed, for example, by frequent cleaning in the dishwasher. A groove that is too deep could impair the stability of the outer layer, while a groove that is too shallow may not offer the desired thermal advantages. The interaction between the outer layer and the interior layer is not adversely affected by the groove depth according to the disclosure, as the groove depth according to the disclosure leaves the mechanical bond between the layers intact over the entire surface area.

The effect 1 described above, the bimetal effect, can only be mitigated by geometric attenuations in the outer layer. According to the disclosure, the geometric attenuations are thus only provided in the surface of the outer layer (e.g. a plurality of grooves extending in a circle at different radii or radial grooves that divide the outer layer optically into “pie slices”, or a combination of both).

According to an advantageous embodiment of the disclosure, the groove is designed with sharp edges. The groove can be produced by different suitable methods; a removal of material by machining has proven to be particularly simple and effective.

In a first variant embodiment, the outer surface of the outer layer and the groove walls of the groove can be designed so as to be rounded, i.e. so as to have a radius. Such rounded edges are generally sturdier and more resilient.

In another preferred variant embodiment, however, the outer layer and the groove walls can be designed with sharp edges and preferably form an angle of 90° to 95°, preferably 90°. According to the disclosure, it is also possible to undercut the groove walls, so that the angle can also be in the range of 80° to 89°. This specific design of the groove walls in relation to the outer surface of the outer layer offers a number of advantages. In contrast to rounded edges, this does not result in a reduction of the width at the bottom of the groove and, consequently, of the corresponding effect of the “thin area”, while an “optical” groove width on the surface of the outer layer remains the same. A groove with an angle of approximately 90° can be implemented without affecting durability, as the outer layer is unlikely to tear in this area since it is bonded over its surface area with the interior layer, in particular when the cookware item has been manufactured in a pressure welding process. In addition, such an angle also facilitates the production of the groove, as it enables a precise and consistent manufacture. This leads to an improved quality and uniformity of the end product. The precise design of the groove can be achieved by modern manufacturing techniques such as CNC milling and turning, i.e. a material removal by machining or laser engraving, which enables a high repeatability and consistency in production. This lowers production costs and increases the quality of the end product.

According to the disclosure, it is also possible to create the groove by stamping. Although the material thickness of the resulting groove bottom is the same as the initial thickness of the outer layer, the groove still acts as an accordion-like joint, which also has a positive impact on the described effects. In addition, the sharp-edged design of the groove can offer aesthetic advantages by giving the cookware item a modern and functional design that sets it apart from conventional products. The combination of these functional and aesthetic advantages can increase the attractiveness of the cookware item for consumers who value performance and design.

All in all, the specific angled design of the groove walls in relation to the outer surface of the outer layer thus offers a number of advantages that improve the mechanical stability, manufacturing precision, layer bonding and thermal efficiency of the multilayer base for cookware.

In principle, it is desirable according to the disclosure to design the groove as deep as possible in order to achieve a maximum attenuation. A minimum residual layer thickness of the outer layer of 0.2 mm has proven to be expedient and sufficiently stable. Moreover, a minimum width of the groove of approximately 0.5 mm at the narrowest point has proven to be necessary for a sufficient attenuation.

Advantageously, the groove depth is between 20% and 50%, preferably between 30% and 40%, of the groove width. The specific depth and width of the groove preserves the structural integrity of the outer layer while reducing the thermodynamic disadvantages of the multilayer base.

According to an embodiment of the disclosure, the outer layer or outer surface has a round shape, wherein the width of the groove corresponds to 0.2% to 0.7% of the diameter of the outer surface. This specific design of the groove width in relation to the diameter and shape of the outer surface provides a number of advantages. Firstly, the round design of the outer layer enables an even heat distribution, resulting in an efficient and uniform heating of the food in the preparation space. The round shape also contributes to the structural integrity of the base, as it distributes stresses evenly and minimises potential weak points. Fixing the groove width as a specific percentage of the diameter of the outer surface ensures that the groove is an optimal size to achieve the desired mechanical and thermal properties without compromising the structural integrity of the outer layer. A groove width between 0.2 and 0.7 per cent of the diameter of the outer surface ensures that the groove is wide enough to fulfil the desired thermal function of separation while preserving the stability of the outer layer. This specific dimensioning of the groove width also helps to optimise manufacturing costs, as it makes efficient use of materials. The specific combination of the round shape of the outer layer and the optimal groove width thus contributes to an improved performance, durability and attractiveness of the cookware item.

In principle, the multilayer base according to the disclosure can have any shape suitable for the cookware item in question, for example round, oval or square. The following description is based on a round basic shape purely by way of example.

Preferably, the groove is designed as a groove that extends in a circle in the outer edge area of the multilayer base. This circularly extending groove is constituted by a continuous recess that runs over the entire length around the outer edge area of the outer layer. A positioning in the edge area is very advantageous for thermal reasons, in particular because the effect on a heat transfer to the food being cooked is hardly disturbed or altered there.

The groove can be designed as an annular continuous groove with constant geometric dimensions. This is advantageous in terms of both manufacturing and optics. It is also possible, however, for the groove to include geometric variations or complete interruptions along its length. These interruptions can have different shapes and arrangements, such as a periodic or irregular spacing along the groove. The specific design of the geometric modifications or interruptions can also facilitate the cleaning of the cookware item.

Alternatively, the outer layer can also include a plurality of grooves in its outer surface. According to one embodiment of the disclosure, the multilayer base for a cookware item has a plurality of grooves in the form of concentric circles in the outer surface. This specific arrangement of the grooves further improves the thermal characteristics of the multilayer base by better distributing stresses and deformations caused by the thermal expansion and contraction over the surface. According to the disclosure, one or more of the plurality of grooves can include geometric variations or complete interruptions over their length, while at least one groove is designed as an annular continuous groove with constant geometric dimensions. The combination of at least one continuous groove with at least one interrupted groove is advantageous for stresses and deformations.

The inner surface of the floor layer is in contact with the food and transfers heat to it. The floor layer and its inner surface have different properties to the interior layer; in particular, they are resistant to scratches and abrasion. The inner surface can also include a non-stick coating.

The interior layer acts as a buffer and ensures that heat is transferred efficiently and evenly from the outer layer to the floor layer. The combination of these three layers improves the overall performance of the cookware item, as it ensures an optimal heat distribution and storage, which facilitates a more efficient food preparation. In addition, the three-layer structure contributes to the durability of the cookware item, as each layer provides specific characteristics that fulfil the various requirements during cooking. The outer layer protects against external damage, the intermediate layer ensures an efficient heat distribution, and the floor layer provides a user-friendly surface for food preparation. This construction makes it possible to utilise the advantages of the individual materials in an optimal manner while simultaneously minimising their disadvantages, which, in combination with the groove according to the disclosure, produces a high-quality and durable cookware item.

The multilayer base can be manufactured using various methods for joining the layers, such as bonding or welding. These methods ensure a robust and durable joining of the metal layers. After joining, the multilayer base is shaped to the desired form to ensure an even and stable surface. A heat treatment can be carried out to reduce stresses in the material and improve heat distribution. It is possible to form the groove according to the disclosure as a final step, although it is also possible to add it prior to the assembly of the individual layers or prior to the heat treatment.

According to the disclosure, different cross sections can be provided for the groove. For example, it can be designed with sharp edges at right angles, it can have rounded corners between groove walls of the groove and the bottom of the groove, the transitions to the outer surface can also be rounded, or combinations of the aforementioned design options can be provided. In principle, the grooves can be designed so as to be symmetrical or asymmetrical in cross section; for example, they can also be designed as indentations with a triangular or analogous basic shape.

The multilayer base according to the disclosure advantageously enables a reduction in the overall material thicknesses in the area of the base by way of the improved base stability.

### BRIEF DESCRIPTION OF THE DRAWINGS

The disclosure will now be explained in more detail with the help of the following figures. The figures schematically show a preferred example embodiment by way of example only; the disclosure is not intended to be limited to the dimensions and shapes shown. The figures show:

FIG. 1: a cookware item from below with a groove extending in a circle in the edge area of an outer surface,

FIG. 2: a schematic representation of a cross section of the edge area of a multilayer base with the groove,

FIG. 3: a cookware item from below with a plurality of grooves in the form of concentric circles in the outer surface of the multilayer base,

FIG. 4: a cross section of a first variant embodiment of a suitable multilayer base,

FIG. 5: a cross section of a second variant embodiment of a suitable multilayer base, and

FIG. 6: shows different groove shapes in cross section.

### DETAILED DESCRIPTION OF THE DRAWINGS

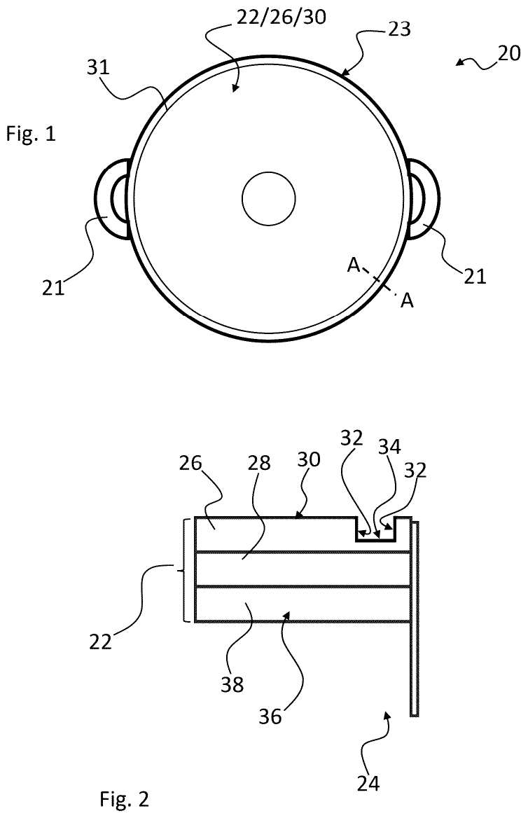

FIG. 1 shows a cookware item 20 from below, in the example embodiment shown a conventional pot with a multilayer base 22. The cookware item 20 includes a wall 23 that adjoins an edge area of the multilayer base 22, thereby forming a preparation space 24 inside the cookware item 20. Handles 21 are arranged on an outer wall surface. The cookware item 20 can also be designed so as to be of one piece, the wall 23 and the multilayer base 22 having the same structure and running into one another.

The figures further show that the multilayer base 22 in the shown example embodiment is composed of an outer layer 26, an adjacent interior layer 28 and a floor layer 38 adjacent to the interior layer. The outer layer 26 and the floor layer 38 can be made of the same material, for example stainless steel, although the different layers 26, 28, 38 can also be made of different materials.

The outer layer 26 is arranged on an outer side of the cookware item 20 and comes into contact with a heat source, for example an induction stovetop. The interior layer 28 is respectively joined over its entire surface area with the outer layer 26 and the floor layer 38 and forms an intermediate layer between the outer layer 26 and the floor layer 38.

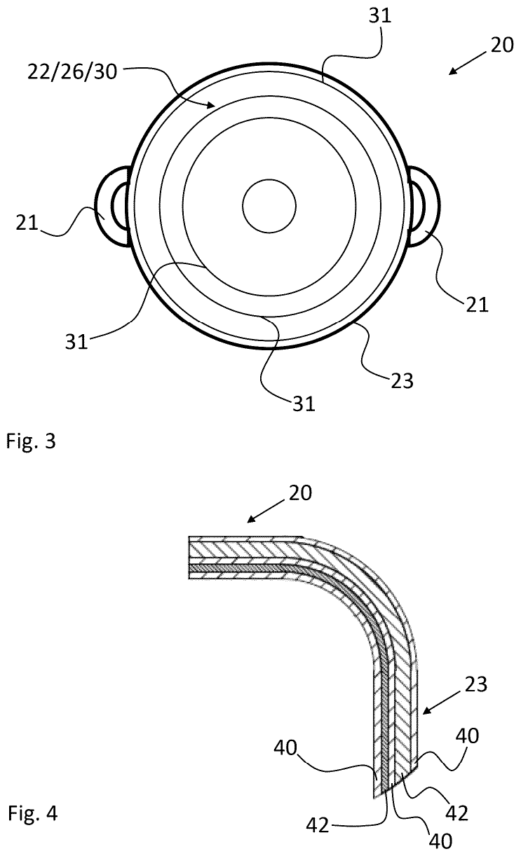

The outer layer 26 includes one or more grooves 31 in its outer surface 30. As shown in FIG. 1, the groove 31 can be arranged as a groove 31 that extends in a circle in the edge area of the outer surface 30 of the outer layer 26. According to the embodiment shown in FIG. 3, it is also possible, however, for a plurality of grooves 31 to be provided as circular grooves 31. Notwithstanding the foregoing, other orientations and arrangements of grooves 31 are also conceivable.

The grooves 31 are designed so as to reduce any disadvantageous effects that may occur, in particular those caused by rapid cooling or heating, for example bimetallic effects and/or the effects of compressive and tensile forces.

FIG. 2 shows a greatly simplified cross-sectional view of the multilayer base 22 in the area of a groove 31 (approximately at position A-A in FIG. 1). The structure of the grooves 30 is clearer here. The groove includes groove walls 32 and a groove bottom 34; in the example embodiment shown, the groove depth T is 0.3 mm at a layer thickness H of the outer layer 26 of approximately 0.5 mm. In the example embodiment shown, the groove width B is 1 mm, which corresponds to approximately 0.5% of the diameter of a conventional round outer surface 30 of 210 mm. The groove walls 32 and the groove bottom 34 also form an angle of 90° according to the example in FIG. 2. The groove depth T is 20% to 50%, preferably 30% to 40%, of the groove width B.

It is essential that the groove 31 does not extend through the entire outer layer 26 so as to expose the interior layer 28, but that the groove 31 extends exclusively into the outer layer 26 and the interior layer 28 remains covered by the outer layer 26. The floor layer 38 forms an inner surface 36 facing the preparation space 24 for heating food to be cooked.

In the example embodiment shown in FIG. 2, the groove 31 is designed with sharp edges, and the outer surface 30 of the outer layer 26 and the groove walls 32 of the groove 31 respectively form an angle of approximately 90°.

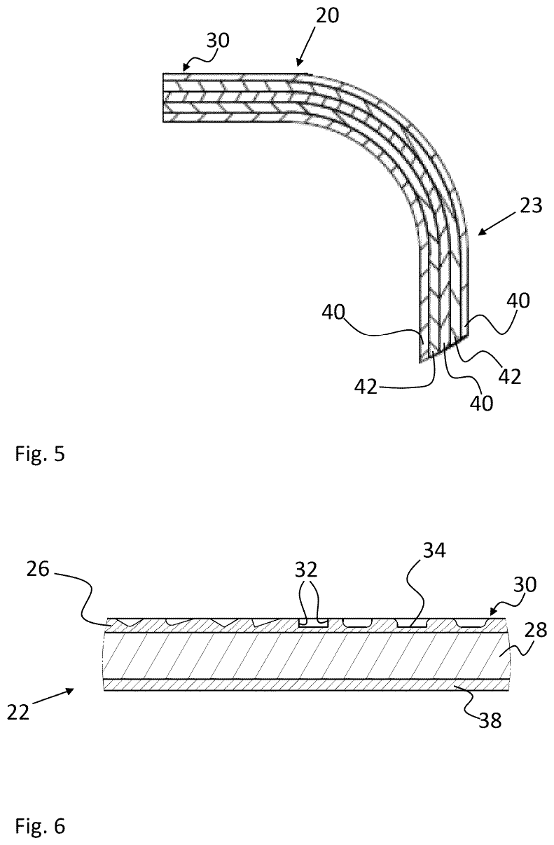

FIGS. 4 and 5 show different structural variants of the multilayer base 22 by way of example. In the variant embodiment according to FIG. 4, the multilayer base 22 is composed, starting from the preparation chamber 24 and moving towards the outer surface, of the following plies:
Steel layer 40
Aluminium layer 42
Steel layer 40
Aluminium layer 42
Steel layer 40

The steel layer 40 forming the outer surface 30 is preferably suitable for inductive heating.

In the variant embodiment shown in FIG. 5, the multilayer base 22 has a three-ply aluminium core. Starting from the preparation space 24 and moving towards the outer surface, the resulting layers are as follows:
Steel layer 40
Aluminium layer 42 (alloy)
Aluminium 42
Aluminium layer 42 (alloy)
Steel layer 40

The steel layer 40 forming the outer surface 30 is preferably suitable for inductive heating.

FIG. 6 shows a section of a multilayer base 22. Various embodiments of the groove 31 according to the disclosure are shown side by side in cross section by way of example. As can be seen here, the grooves can be designed so as to be, for example, symmetrical or asymmetrical, and/or the transition from the groove bottom 34 to the groove walls 32 can be designed so as to be at right angles or rounded. The groove 31 can also have a triangular shape or a curved groove bottom 34. In particular in the case of these last cross-sectional shapes, the transition from the groove bottom 34 to the groove walls 32 is continuous.

In the example embodiments shown, the grooves 31 have a constant groove depth T and groove width B over their entire length; in alternative variants, however, interruptions and geometric variations can also be provided along their length due to special requirements.

1. A multilayer base for a cookware item with a preparation space for the preparation of food, including an outer layer that faces a substrate and that is made of a first material and an interior layer that is adjacent to the outer layer in the direction of the preparation space and that is made of a second material, wherein the outer layer includes at least one groove in its outer surface that faces away from the interior layer, wherein a groove depth is between 50% and 95% of a layer thickness of the outer layer.

2. The multilayer base according to claim 1, wherein the groove depth has a depth whereby the residual layer thickness of the outer layer is at least 0.2 mm.

3. The multilayer base according to claim 1, wherein the groove is designed with sharp edges, with right-angled transitions from groove walls to a groove bottom and/or to the outer surface of the outer layer.

4. The multilayer base according to claim 1, wherein the groove is designed to be rounded in the area of the transitions from the groove walls to the groove bottom and/or to the outer surface of the outer layer.

5. The multilayer base according to claim 1, wherein the outer surface of the outer layer and the groove walls of the groove form an angle of 85° to 95°.

6. The multilayer base according to claim 1, wherein the groove walls of the groove and a groove bottom form an angle of 85° to 95°.

7. The multilayer base according to claim 1, wherein the groove has a groove width of at least 0.5 mm at its narrowest point.

8. The multilayer base according to claim 1, wherein the outer surface of the outer layer is designed so as to be round and the groove width is 0.2 to 0.7%, of the diameter of the outer surface.

9. The multilayer base according to claim 1, wherein the groove in the outer edge area of the multilayer base is designed as a groove that extends in a circle.

10. The multilayer base according to claim 1, wherein the groove has interruptions along its length.

11. The multilayer base according to claim 1, wherein a plurality of grooves are formed in the outer surface.

12. The multilayer base according to claim 1, wherein a design as an at least three-layer multilayer base, wherein at least one interior layer is arranged as an intermediate layer between the outer layer and a floor layer and the floor layer forms the inner surface.
